(19) United States
(12) Patent Application Publication
(10) Pub. No.: US 2024/0215762 A1
(43) Pub. Date: Jul. 4, 2024

(54) DOUBLE WALLED GEL WATER BOTTLE

(71) Applicant: Numair Fakir, Brea, CA (US)

(72) Inventor: Numair Fakir, Brea, CA (US)

(21) Appl. No.: 18/092,787

(22) Filed: Jan. 3, 2023

(51) Int. Cl. A47J 41/00

(52) U.S. Cl. CPC A47J 41/0072; A47J 41/0005; A47J 41/0088

(57) ABSTRACT

A 128 oz. stainless steel/glass/plastic water bottle novel assembly where the bottle consists of a standard mouth lid including a container, a cap mounted to an upper end of the container and has holes therein connected to a straw leading to the lower end of the bottle, and a handle which is attached to the bottle assembly. A double-walled insulation mechanism with gel within the walls to maintain the temperature of liquid for a longer period of time.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates to an improved structure of a bottle assembly and particularly to a double walled gel bottle for enhanced cooling time.

### Description of the Related Art

Insulated bottles which are now widely used are usually made of glass and are of the double-walled construction, with a vacuum in the space between the two walls. Such glass bottles have the advantages of high insulating properties but are poor in resistance to mechanical shocks. Thus, if any mechanical shock is given, breakage of the bottles and the effluence of their contents can result. As bottles with high resistance to mechanical shocks there have recently been proposed metal bottles, which are made of a suitable metal material such as stainless steel, some of which have been put into practical use. For example, there is a metal bottle which is made of stainless steel and is of a vacuum insulated, double-walled construction. In order to decrease the heat transfer the inner bottle is polished and a composite material is arranged in the vacuum space formed between inner and outer bottles. The composite material generally comprises one or more lustered thin steel or aluminum plates and glass wool layers. In an alternative form the vacuum space is packed with a large amount of a mixture comprising a fine-grained powder of graphite, diatom earth and calcium oxide.

These metal bottles have the advantage of high resistance to mechanical shocks, and their outer bottle per se can serves as an outer jacket. However, these metal bottles are considerably inferior to glass bottles in thermal insulating properties, which are the most important properties of bottles. This problem mainly depends on the physical properties of the metal used and the construction of the bottle. Particularly, the metal material contains some gases such as hydrogen, so that the gas would be liberated from the interior of the metal into the vacuum space, with the result that the vacuum becomes progressively worse with time. Thus, it is difficult with such a metal bottle to maintain the thermal insulating properties for a long time. In the prior art metal bottles, it has been attempted to prevent the vacuum's lowering by using a getter material with which the gas released from the metal into the vacuum space combines to form stable compounds. However, there is no prior art double-walled gel bottle with thermal insulating properties which are as good as glass or metal bottles.

Thus the current invention aims to present a water bottle that is double-walled and uses gel within the walls to keep the temperature maintained thus provides not only conventional features but also provides advanced features to improve the user's experience in using and handling the bottle assembly. None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to advancement in offering water bottle assembly with the provision of cold liquid for a longer period of time.

It is also the primary object of the invention to provide a bottle that is of compact and economic construction.

It is further the objective of the invention to provide an aesthetically pleasing water bottle that is double-walled and has gel within the walls to serve the beautification and cooling function.

It is the further objective of the present invention to provide the simplicity of its design which is easy to hold and economical to manufacture.

It is also the objective of the invention to provide portability. Being wide open, a sturdy holding place, and light in weight enable a user to take it on business trips, vacations, or any on-the-go activity easily.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Many different assemblies have been developed over the years to give an individual an exclusive drinking experience. Most of these assemblies are complicated, lower quality, not properly insulated, and have leakage issues. The current invention proposes an advancement in water bottle assembly which is light in weight, is double-walled and uses gel between the walls to maintain the temperature of the liquid for a longer period.

The bottle can comprise an inner and outer layer of stainless steel, plastic or glass where the inner and outer bottles are joined together at tip portions of their bottlenecks to form a double-walled construction, the space formed between said inner and outer bottles being a vacuum, characterized in that the wall surfaces of the inner and outer bottles that surround the vacuum space are provided with at least one metal deposit. The deposit will be in form of gel which is moveable within the walls of the bottle and helps in improvising the temperature of the liquid contained in the bottle.

In a preferred embodiment, at least one metal deposit is formed on the whole of the wall surfaces that surround the vacuum space, i.e., the outer surface of the inner bottle and the inner surface of the outer bottle, except for a part or all of the bottleneck surfaces in the space. At least one metal deposit may consist of soft gel which prevents heat transfer that causes a temperature increase of the liquid in the bottle.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the multiple views of a double walled gel water bottle incorporating the embodiments of the invention.

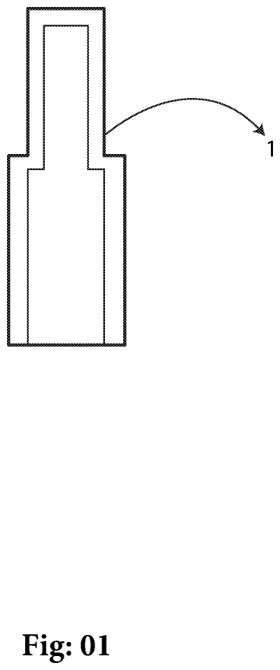

I: An insulated 128 oz steel bottle with a cap and straw apparatus and double-walled body with gel for insulation purposes wherein:
a heavy 128 oz. stainless steel/plastic/glass water bottle;
the inner diameter of the bottle is 4.5 inches;
a bottle having an upper and lower end;
a drinking straw attached to the upper cover of the bottle leading to the lower end of the bottle;
a bottle body having an upper opening defining a mouth for receiving a selected beverage into the interior of the bottle body;
a bottle with a larger diameter allowing large cubes of ice to enter into the body of the bottle;
a dual-walled assembly with gel allowing the liquid to remain cold for a longer period of time; and,
a sturdy handle attached to the upper part of the bottle for better grip and handling.
